(19) United States
(12) Patent Application Publication
(10) Pub. No.: US 2010/0260913 A1
(43) Pub. Date: Oct. 14, 2010

(54) Oxidative Stabilizing of Sterols and Sterol Esters

(75) Inventors: Peter Horlacher, Bellenberg (DE); Michael Muller, Dietenheim (DE); Katja Beck, Bellenberg (DE)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/747,939

(22) PCT Filed: Dec. 4, 2008
(86) PCT No.: PCT/EP08/10263

§ 371 Date: Jun. 14, 2010

(30) Foreign Application Priority Data
Dec. 13, 2007 (EP) 07024184.9

(51) Int. Cl. A23L 3/3481

(52) U.S. Cl. 426/546

(57) ABSTRACT

The invention relates to a method for the production of oxidation-stable sterol formulations, wherein catechins and/or the derivatives thereof are added to the sterols or sterol esters, and to the formulations produced according to said method. The catechins are preferably used in an amount of 20 to 1000 ppm, based on the sterol or on the sterol ester. Green tea extract may be incorporated as the catechin formulation. The formulations containing sterols produced according to said method have very high oxidative stability and have no displeasing aftertaste.

### FIELD OF THE INVENTION

The invention relates to the field of foods and relates to a method for producing oxidation-stable sterols and sterol esters, the formulations produced by this method and also foods which comprise these formulations.

### PRIOR ART

The use of sterols and sterol esters as cholesterol-lowering food additives primarily became known via the first approvals for addition of sterols and sterol esters to spreadable fats. In the interim it has been extended to many new food sectors such as, for example, milk products and baked goods. The requirements with respect to quality and food safety must likewise conform to the increasing number of products in which they are used. The tests of food stability required thereby are closely associated with determinations of the keeping quality of the raw materials.

Evaluations of the keeping quality primarily require the consideration of decomposition reactions which proceed via oxidation processes.

The oxidation of sterols and sterol esters proceeds as is known via enzymatic or non-enzymatic pathways, wherein in the production and storage of sterol raw materials and further processing thereof into end products, the non-enzymatic pathway is predominantly of relevance. A differentiation is made in the case of this pathway again into two essential mechanisms: autoxidation as oxidation which is initiated via free radicals, and also photooxidation as a non-free-radical oxidation. Since raw materials and further-processed products thereof are generally stored with the exclusion of light, in the assessment of the oxidative stability of sterols and sterol esters, free-radical oxidation takes the important position.

Oxidative breakdown begins via free radicals which lead via peroxide radicals to various sterol hydroperoxides. Elevated temperature, oxidative oxygen species and metals are initiators in this case. Of the sterol hydroperoxides, the C7 hydroperoxide can be detected first. Heating or storage of sterol 7-hydroperoxides then leads to 7-hydroxysterols and 7-ketosterols as secondary oxidative breakdown products (Smith L. L., 1987—Cholesterol autoxidation 1981-1995, Chem. Phys. Lipids 31: 453-487).

The autoxidation of fatty acid esters of sterols proceeds by the same free-radical mechanism as that of the free sterols. However, derivatization of the sterols gives further points of attack, so that the oxidative attack can proceed either preferentially on the sterol moiety or on the fatty acid moiety. Intra-molecular oxidation of fatty acid esters of sterol is thus also possible.

After incorporation of the sterol esters into food systems, the sterol-degrading reactions become additionally more complex. The oxidation rate here is not only dependent on the structure of the fatty acid moiety and the sterol, but also changes with the matrix into which the ester is incorporated and the temperature.

Experiments by Yanishlieva-Maslarova and Marinova (Yanishlieva, N. and Marinova, E., 1980, Autoxidation of sitosterol I: Kinetic studies on free and esterified sitosterol. Riv. Ital. Sost. Grasse 57: 477-480. Yanishlieva-Maslarova, N., Schiller, H., Seher, A., 1982, Die Autoxidation von Sitosterin III. Sitosteryl-stearart. [The autoxidation of sitosterol III. Sitostearyl stearate.] Fette, Seifen, Anstrichmittel 84: 308-311.) on the kinetics of the autoxidation of pure sitosterol and pure sitosterol esters have found that at the start of the autoxidation the conversion rate of the esterified sitosterol is substantially higher than that of the free sitosterol, whereas with advancing oxidation when, in addition to the peroxides, 7-hydroxysterol and 7-ketosterol have already accumulated, the oxidation rate of the free sitosterol is higher. A physical mechanism in the form of steric hindrance is conceivable, which causes oxidation first to take place on the fatty acid moiety and thus limit the oxidation on the sterol molecule. In the case of intramolecular oxidation, the already oxidized fatty acid can subsequently attack the sterol moiety in the same molecule. These hypotheses also show that the oxidative breakdown of the esterified sterols is still substantially unexplained.

Even if pure sterols are still relatively stable at room temperature and the tendency to oxidation does not markedly increase until at elevated temperatures, studies of sterol-containing foods for oxidative breakdown products of sterols have found that even the raw materials have a significant content of sterol oxides which does not significantly increase during processing in foods (Laura Soupas, University of Helsinki, Faculty of Agriculture and Forestry, Department of Applied Chemistry and Microbiology, Food chemistry, Helsinki 2006, Oxidative stability of phytosterols in food models and foods. Doctoral dissertation, November 2006).

It is therefore absolutely necessary to add stabilizers to pure sterols and also esters thereof even for storage at room temperature. Suitable antioxidants and preservatives for sterol esters are frequently tocopherols, lecithins, ascorbic acid, parabens, butylated hydroxytoluene or butylated hydroxyanisole, sorbic acid or benzoic acid and salts thereof. Tocopherols are used most frequently as antioxidants. In the Japanese patent application JP 2004018678 fatty acid esters of sterols having a high oxidative stability are disclosed. This stability is achieved by adding a mixture of ascorbic ester and lecithin to the sterol esters, preferably vitamin E is additionally added to the antioxidant mixture. Alpha-tocopherol in combination with ascorbic acid is also described in international application WO 00/1491 A1 as an antioxidant of sterol and stanol esters in milk products.

In the international application WO 2005/099484 A1, special tocopherol compositions having high proportions of gamma- and delta-tocopherol are compared with the customarily used alpha-tocopherol. It was found that at comparable antioxidant activity, an adverse off taste of the conventional antioxidants does not occur when gamma- and delta-tocopherol are used.

It was an object of the present invention to provide sterol-ester-containing formulations which are distinguished by an improved oxidative stability and are highly compatible with foods. The formulations should have good sensory and organoleptic properties in the foods and be easy to process.

### DESCRIPTION OF THE INVENTION

The invention relates to the use of catechin-containing green tea extract or catechins for the oxidative stabilization of sterol (ester) formulations, and also to the method for producing oxidation-stable sterol formulations, in which catechins and/or derivatives thereof are added to sterols or sterol esters.

Sterol and/or Stanol

In the present invention, sterols which are obtained from plants and plant raw materials and are termed phytosterols and phytostanols are used. Known examples are ergosterol, brassicasterol, campesterol, avenasterol, desmosterol, clionasterol, stigmasterol, poriferasterol, chalinosterol, sitosterol and mixtures thereof, among which β-sitosterol and campesterol are preferably used. The hydrogenated saturated forms of sterols, termed stanols, likewise come under the compounds used, but, owing to their higher oxidative stability, require fewer antioxidants, and here also β-sitostanol and campestanol are preferred. Plant raw material sources which are used are, inter alia, seeds and oils of soybeans, canola, palm kernel, corn, coconut, rape, sugarcane, sunflower, olive, cotton, soy, peanut or products from tall oil production.

Preferably, esters of the sterols obtained from plants and plant raw materials are stabilized with the catechins and derivatives thereof, since these surprisingly have a higher oxidation sensitivity. Among the sterol esters, preference is given to esterification products with saturated and/or unsaturated fatty acids having 6 to 22 carbon atoms, particular preference is given to sterol esters of fatty acids having fatty acid chain lengths of 12 to 18 carbon atoms, and also sterol esters of fatty acids having medium-chain fatty acids of 8 and 10 carbon atoms.

However, the invention is not limited to this type of esters. For instance, esters of phenolic acid are also usable, in particular derivatives of cinnamic acid, caffeic acid and ferulic acid.

In this case, naturally occurring esters of plant raw materials can be obtained directly, or the sterol/stanol esters are produced by transesterification with other esters. Likewise, derivatives can be used which result from esterification of free sterols or stanols with the corresponding fatty acids.

### Green Tea Extract and Catechins

The green tea extracts which have been obtainable on the market for some years are known for their antioxidative activity in the body. The active principle is principally assigned to the polyphenols which comprise flavonoids, flavanols, flavandiols and phenolic acids. Depending on the climate and location, green tea plants (Camellia sinensis) contain up to 36% polyphenols based on dry matter. The predominant part of the polyphenols are flavanols, better known under the name catechins (FIG. 1) and these are in turn differentiated into the principal catechins (−)-epigallocatechin (EGC), (−)-epigallocatechin 3-gallate (EGCG), (−)-epicatechin (EC) and (−)-epicatechin 3-gallate (ECG). In addition to the desired physiological activities such as antimutagenic, anticarcinogenic, antiviral and antibacterial properties, the strongest antioxidative effect is also ascribed to epigallocatechin 3-gallate (EGCG). Catechins, owing to their strong antioxidative capabilities, can contribute to preventing cardiovascular diseases and cancers.

Catechins inhibit carcinogenesis by blocking the endogenous formation of N-nitroso compounds. They also activate glutathione peroxidase, a highly active anti-oxidative enzyme and are active traps of the radicals hydrogen peroxide, superoxide and singlet oxygen. They are even used as antioxidants in cosmetics products, in order to decrease skin aging and damage due to environmental effects and UV light.

Numerous methods for the extraction of polyphenol-rich extracts are described in the literature. 150 ml of green tea contain 0.7-1.3 mg of epicatechin, 4.3 to 8.6 mg of epicatechin gallate, 0.5 to 1 mg of epigallocatechin and 10 to 25 mg of epigallocatechin gallate. Customarily, a liquid extract is produced by heating or boiling the tea leaves with water or water-miscible solvents, which extract is then concentrated by drying to powder. By way of example, the international applications WO 96/28178 A1, WO 01/56586 A1 may be mentioned here.

Although catechins are the main component of green tea, they occur in many other tree species, and so the subject matter of the invention should not be limited to green tea extract.

| | |
|---|---|
| | FIG. 1 |
| 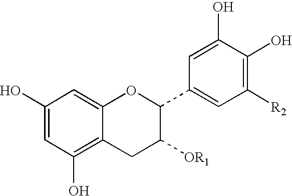 | |

| | R1 | R2 |
|---|---|---|
| (−)-Epicatechin | H | H |
| (−) Epigallocatechin | H | OH |
| (−) Epicatechin 3-gallate | Galloyl | H |
| (−) Epigallocatechin 3-gallate | Galloyl | OH |

The content of catechins (including the corresponding esters) in the oxidation-stabilized sterol (ester) formulation is 20-1000 ppm, preferably 30-500 ppm, particularly preferably 50-300 ppm. If green tea extract is used, the amount of the extract must be selected in accordance with the catechin concentration present therein.

It is surprising that the stabilized sterol formulation containing the otherwise bitter-tasting catechins, already at this concentration, no longer has an off taste or adverse aftertaste and at the same time exhibits a better antioxidative activity than sterol formulations having other antioxidants.

The preferred catechin used is epigallocatechin 3-gallate, since this catechin has the highest anti-oxidative activity. Concentrations of 30 to 500 ppm, preferably 30 to 200 ppm, are already sufficient for a high antioxidative activity and do not show a bitter off taste in the sterol (ester), or in the food formulations produced therewith.

Catechins are readily soluble in water and water-miscible organic liquids. Therefore, they cannot be directly incorporated into the somewhat lipophilic sterols and sterol esters. Therefore, if green tea extract or catechins are used for stabilization, advantageously, emulsifier-containing premixes containing the catechins or the green tea extract are produced.

These catechin concentrates may be formulated with and without water. The aqueous concentrates, after dissolution in oil, produce a W/O microemulsion.

Correspondingly, the invention further relates to the method for producing oxidation-stable sterol formulations in which
a) green tea extract is dissolved in water,
b) this solution/dispersion is added to at least one emulsifier melted by heating,
c) optionally an auxiliary oil is added for emulsification and
d) the water is removed by vacuum drying, freeze drying or spray drying and
e) the resultant powder is added to a molten sterol (ester) and cooled with constant stirring.

If the green tea extract is not admixed with water, but dispersed directly in the molten emulsifier, removal of the water is unnecessary.

A good further processing into hydrophilic or lipophilic matrices gives the catechin concentrates which contain a hydrophilic and also a lipophilic emulsifier and comprise an additional auxiliary oil. As auxiliary oil, customary vegetable oils may be used such as sunflower oil, fish oils, conjugated linoleic acids or medium-chain triglycerides. The formulation which may be further processed most simply and has the best physicochemical stability has the following composition:

| | |
|---|---|
| Green tea extract (approx. 70% catechins | 5-20% by wt. |
| based on the dry matter) | |
| Glycerol monooleate | 10-35% by wt. |
| Esters of tartaric acid | 10-35% by wt. |
| C8/C10 triglycerides | 10-50% by wt. |
| Water | 0-10% by wt. |

This formulation may be incorporated simply and rapidly into sterols and sterol esters.

In the further processing, it was in addition observed that the component of the auxiliary oil may also be replaced directly by the use of sterols or sterol esters.

Preferred formulations of this composition are:

| | |
|---|---|
| Green tea extract (approx. 70% catechins | 5-20% by wt. |
| based on the dry matter) | |
| Glycerol monooleate | 10-35% by wt. |
| Esters of tartaric acid | 10-35% by wt. |
| Sterol esters | 10-50% by wt. |
| Water | 0-10% by wt. |

The invention therefore further relates to the method for producing oxidation-stable sterol formulations in which
a) green tea extract is optionally dissolved in water,
b) the extract directly, or the aqueous solution/dispersion, is added to an emulsifier melted by heating,
c) molten sterols and/or sterol esters are added for emulsification and
d) optionally the water is removed by vacuum drying, freeze drying or spray drying and
e) the molten mixture is cooled with constant stirring.

If when catechins are used in sterols and sterol esters, it is wished to avoid the use of emulsifiers, derivatives of catechin can alternatively be used, since these have an improved oil solubility compared with free catechins and can be incorporated directly into sterols and sterol esters without adding an emulsifier.

Surprisingly, the glycerides and esters of catechin, preferably catechins esterified with long-chain fatty acids of a carbon length of C12 to C22 (source: Polaris Moulin du Pont, 29170 PLEUVEN, France), also display a higher oxidation inhibition than the antioxidants customarily used. They may be processed excellently in lipophilic matrices. For this purpose the catechin esters which are fat soluble or oil soluble are added to the molten sterol esters under protective gas and stirred until they solidify.

Advantageously, combinations of catechins and other antioxidants give synergistic effects. In particular, the combination of catechin with ascorbyl palmitate exhibited outstanding stability values when employed in sterol esters. On heating of milk products on pasteurization, these products have very good sensory properties. In a mixture with ascorbyl palmitate, in addition, scarcely any discoloration occurs.

### Use

The sterol formulation stabilized according to the invention can be incorporated in a simple manner into foods selected from the group formed by spreadable fats, margarine, butter, vegetable oils, frying fats, peanut butter, mayonnaise, dressings, sauces, cereals, bread and bakery products, cakes, wheat bread, rye bread, toast bread, crispbread, ice cream, puddings, milk products, fermented milk products, yoghurt, quark, cream, cheese, spreadable cheese, eggs, egg-based products, confectionery, chocolate, chewing gum, muesli bars, sorbet, milk drinks, soy drinks, fruit juices, vegetable juices, fermented drinks, noodles, rice, sauces, meat and sausage products.

Particularly water-containing and temperature-sensitive food products such as drinks and milk products, such as, for example, milk, milk drinks, whey, yoghurt drinks, fruit juices, fruit juice mixtures, fruit juice drinks, vegetable juices, carbonated and noncarbonated drinks, soy milk drinks or protein-rich liquid food replacement drinks, and also fermented milk formulations, yoghurt, drinking yoghurt or cheese preparations are suitable bases for the oxidation-stable sterol formulations according to the invention. These water-containing products have a high stability during storage. This means that no flavor impairments due to oxidation may be observed.

The invention therefore further relates to food products which contain the oxidation-stabilized sterol formulations according to the invention, customarily in an amount of 0.1 to 50% by weight, preferably 0.5 to 20% by weight, particularly preferably 1 to 10% by weight, of the sterol formulations based on the total weight of the foods.

### EXAMPLES

### Example 1

### Production of Catechin-Containing Sterol Esters

### Production of the Catechin Mixture:

25 g of glycerol monooleate (Monomuls 90-018, manufacturer: Cognis GmbH, Illertissen) and 25 g of esters of tartaric acid (Lamegin DWP 2000, manufacturer: Cognis GmbH, Dusseldorf) are heated to approximately 50° C. and mixed and melted with stirring. Subsequently, 9.1 g of the catechin mixture consisting of Green Tea Low Caffeine Dry Extract (source Cognis Iberia) (caffeine: 0.33%; epigallocatechin gallate: 42.7%; total catechins: 70.46%) in 3.4 g of water are stirred into the emulsifier premix. After homogeneous distribution, 37.5 g of C8/C10 medium-chain triglycerides (Delios V—Cognis GmbH, Dusseldorf) are added. The water is then removed by freeze drying.

### Production of the Mixture of Sterol Ester and Catechins:

Unstabilized sterol ester (Vegapure 95 FF, Cognis GmbH, Dusseldorf) was heated to 50° C., the desired amount of catechin mixture added and the mixture was stirred with slow cooling to room temperature.

1a)
100 g of Vegapure 95 FF, unstabilized,
and 1.5 g of catechin mixture (equivalent to 1000 ppm of total catechin)
1b)
100 g of Vegapure 95 FF, unstabilized,
and 0.3 g of catechin mixture (equivalent to 200 ppm of total catechin)

### Studies:

A trained team of experts rated the products with respect to their taste directly after production and after storage over two weeks at 5 to 8° C.

The oxidative stability was determined by means of a Rancimat test. For this purpose, 5.0 g of the corresponding mixture were treated at 120° C. with 20 l of air/h.

The induction periods (measure of the oxidative stability) of the individual mixtures were:

TABLE 1
Rancimat test of Vegapure 95 FF, conditions:
5 g at 120° C. with 20 l of air/h

| Antioxidant | Induction time |
|---|---|
| Sterol ester (Vegapure 95 FF) | 1.4 h |
| unstabilized (1) | |
| (1) containing 550 ppm of Covi-ox T 90 | 4.3 h |
| EU + 500 ppm of ascorbyl palmitate | |
| (1) containing 200 ppm of catechin | 6.3 h |
| (1) containing 300 ppm of catechin | 10.2 h |

As the table shows, the mixtures containing catechin exhibit a significantly higher oxidative stability compared with an antioxidant mixture of mixed tocopherols and ascorbyl palmitate. A foreign aroma could not be detected in any of the stabilized samples.

### Example 2

### Production of the Catechin-Containing Sterol Esters without Auxiliary Oil

25 g of glycerol monooleate (Monomuls 90-018, manufacturer: Cognis GmbH, Dusseldorf) and 25 g of esters of tartaric acid (Lamegin DWP 2000, manufacturer: Cognis GmbH, Dusseldorf) are heated to approximately 50° C. and mixed and melted with stirring. 9.1 g of the catechin mixture consisting of Green Tea Low Caffeine Dry Extract (source Cognis Iberia) (caffeine: 0.33%; epigallocatechin gallate: 42.7%; total catechins: 70.46%) in 3.4 g of water are then stirred into the emulsifier premix. After homogeneous distribution, 37.5 g of unstabilized sterol esters (Vegapure 95 FF—Cognis GmbH, Dusseldorf) which were melted at 50° C. are added and subsequently freeze dried. The Rancimat test was performed in a similar manner to table 1.

Rancimat test similar to above:

TABLE 2
Rancimat test of Vegapure 95 FF, conditions:
5 g at 120° C. with 20 l of air/h

| Antioxidant | Induction time |
|---|---|
| Sterol ester (Vegapure 95 FF) | 1.4 h |
| unstabilized (1) | |
| (1) containing 200 ppm of catechin | 6.6 h |

### Example 3

### Production of Sterol Esters Containing Catechin and Ascorbyl Palmitate

Unstabilized sterol ester (Vegapure 95 ER, Cognis GmbH, Dusseldorf) was heated to 50° C., the desired amount of catechin mixture (according to example 1) and of ascorbyl palmitate was added and the mixture was stirred under slow cooling to room temperature.

TABLE 3
Rancimat test of Vegapure 95 ER, conditions:
5 g at 120° C. with 20 l of air/h

| Antioxidant | Induction time |
|---|---|
| Sterol ester (Vegapure 95 ER) | 2.6 h |
| unstabilized (2) | |
| (2) containing 200 ppm of catechin | 16.5 h |
| (2) containing 200 ppm of catechin + | 25.0 h |
| 500 ppm of ascorbyl palmitate | |

The Rancimat test showed significant synergistic effects in the combination catechin and ascorbyl palmitate.

### Example 4

### Use of the Catechin-Containing Sterol Esters in Milk

1.5 g of sterol esters produced according to examples 1a, 1b, example 2 and example 3 were added in each case to 100 ml of low-fat milk (1.5% fat) with vigorous stirring at 60° C. in the Ultra-Turrax. After pasteurization at 80° C., the mixture was homogenized at 200 bar and cooled to 8° C. As a comparison, the corresponding amounts of catechin mixture from example 1 without sterol esters were added to the milk after the same process.

All milk formulations containing sterol ester had no off taste due to the addition of the antioxidant. In the case of the sterol-ester-free comparison formulations, a slightly bitter taste could be detected. The milk formulations were stable over the observation period of 4 weeks.

### Example 5

### Use of the Catechin-Containing Sterol Esters in Yoghurt

Four different formulations of sterol-ester-containing milk were produced according to example 4. After the homogenization at 200 bar, the milk formulations were cooled to 45° C. 450 g of the thus prepared milk dispersions were admixed in each case with 50 g of a bacterial starter culture for yoghurt (YC 180 by Chr. Hansen).

The fermentation process was carried out in the incubator at 45° C. After the samples exhibited a pH of 4.5 to 4.6 they were cooled to room temperature. For the mixed yoghurt, 7% by weight of sugar was then added with stirring.

For producing drinking yoghurt, some of the samples were homogenized at 80 to 100 bar (APV high-pressure homogenizer).

In the subsequent taste test, in none of the samples could an unpleasant off taste or foreign aroma due to oxidation stabilization be detected.

What is claimed is:

1. A method of stabilizing sterols and/or sterol esters comprising adding one or more catechins and/or catechin derivatives as stabilizers against oxidation.

2. The method of claim 1, wherein said catechins and/or derivatives thereof are added in an amount of 20 to 1000 ppm of total catechins based on the sterols and/or sterol esters.

3. A method for producing oxidation-stable sterol formulations, comprising adding one or more catechins and/or derivatives thereof to sterols and/or sterol esters.

4. The method for producing oxidation-stable sterol formulations of claim 3, wherein said catechins and/or derivatives thereof comprise green tea extract.

5. The method for producing oxidation-stable sterol formulations of claim 3, wherein said catechins and/or derivatives thereof are added in the form of an emulsion, or in the form of an emulsifier-containing powder.

6. The method for producing oxidation-stable sterol formulations of claim 3, the wherein said catechins and/or derivatives thereof are added in an amount of 20 to 1000 ppm of total catechin, based on the formulation.

7. The method for producing oxidation-stable sterol formulations of claim 3, wherein said catechin derivatives comprise catechin glycosides and/or catechin esters of fatty acids.

8. The method for producing oxidation-stable sterol formulations of claim 3, wherein an emulsion formulation containing one or more catechins, at least one lipophilic emulsifier, at least one hydrophilic emulsifier and optionally one auxiliary oil, is added.

9. The method for producing oxidation-stable sterol formulations of claim 8, comprising the steps of:
a) dissolving green tea extract in water to form a solution or dispersion;
b) adding said solution/dispersion to at least one emulsifier melted by heating;
c) optionally, adding an auxiliary oil for emulsification;
d) removing the water by vacuum drying, freeze drying or spray drying to form a powder; and
e) adding said powder to a molten sterol and/or sterol ester and cooling with constant stifling.

10. An oxidation-stable sterol formulation containing sterols and/or sterol esters and catechins and/or catechin derivatives, wherein said catechins and/or catechin derivatives are present in an amount of 20 to 1000 ppm, based on the oxidation-stable sterol formulation.

11. (canceled)

12. The oxidation-stable sterol formulation of claim 10, wherein said catechin derivatives comprise catechin glycosides and/or catechin esters of fatty acids.

13. The oxidation-stable sterol formulation of claim 10, comprising at least 30 to 500 ppm of epigallocatechin 3-gallate, and, optionally, an emulsifier.

14. A food containing 0.1 to 50% by weight of the oxidation-stable sterol formulation of claim 10.
